(19) United States
(12) Patent Application Publication
(10) Pub. No.: US 2019/0256811 A1
(43) Pub. Date: Aug. 22, 2019

(54) BUFFERED VINEGAR PRODUCTS WITH REDUCED COLOR, ODOR, AND FLAVOR AND METHODS OF PRODUCING THE SAME

(71) Applicant: Isoage Technologies LLC, Athens, GA (US)

(72) Inventors: Richard S. Hull, Athens, GA (US); Bilal Kirmaci, Athens, GA (US); Romeo Toledo, Hull, GA (US); Mo Mui Toledo, Hull, GA (US)

(21) Appl. No.: 16/280,989

(22) Filed: Feb. 20, 2019

Related U.S. Application Data
(60) Provisional application No. 62/632,783, filed on Feb. 20, 2018.

(51) Int. Cl. C12J 1/04; C12J 1/08

(52) U.S. Cl. CPC C12J 1/04; C12J 1/08

(57) ABSTRACT

Embodiments of the present invention provide improved buffered vinegar products having substantially reduced color, odor, and flavor, and methods to produce the same.

### CROSS-REFERENCE TO RELATED APPLICATIONS

This application claims the benefit of U.S. Provisional Application No. 62/632,783, filed Feb. 20, 2018, which is incorporated by reference herein in its entirety.

### BACKGROUND

Vinegar is a widely-used ingredient in domestic cookery. It is also used in various applications in the food industry for its antimicrobial properties, ability to sequester ionic species to prevent color and flavor changes in foods, and as an acidulant and flavoring agent.

### SUMMARY

Various embodiments of the present invention provide improved buffered vinegar products having noticeably reduced color, odor, and flavor as compared to non-treated products.

In some embodiments, the buffered vinegar products of the present invention may have an almost water-like clarity (i.e., substantially clear/transparent and colorless) and a mild characteristic vinegar flavor. In some embodiments, a buttery flavor note may also be present.

In some embodiments, the buffered vinegar products of the present invention are produced by treating a buffered vinegar with an activated carbon. The buffered vinegar to be treated can be concentrated (e.g., by heat or other method) or un-concentrated (also referred to herein as “simple”). In some embodiments, the buffered vinegar to be treated is a concentrated buffered vinegar comprising a heat-concentrated neutralized vinegar adjusted to pH 5.6 by addition of un-neutralized vinegar (e.g., 300 grain vinegar) after concentration. In other embodiments, the buffered vinegar to be treated is a simple buffered vinegar comprising an un-concentrated neutralized vinegar adjusted to pH 5.6-6.0 by addition of un-neutralized vinegar (e.g., 300 grain vinegar).

In some embodiments, the buffered vinegar products of the present invention are produced by passing the buffered vinegar through a bed of granular activated carbon (GAC), followed by filtration to remove eluted fine carbon particles. In other embodiments, the buffered vinegar products of the present invention are produced by mixing the buffered vinegar with powdered activated carbon (PAC) in a batch process, followed by filtration to separate the fine carbon particles from the clarified liquid.

In some embodiments, the carbon may be wetted (e.g., with water or diluted 300 grain vinegar) to prevent the activated carbon particles from disintegrating and/or to prevent a pH spike in the fluid effluent.

In some embodiments, the saturation point of the activated carbon in its adsorption of microbial metabolites may be determined by the clarity of the liquid effluent color as measured by the absorbance of the liquid using a spectrophotometer.

In some embodiments, the activated carbon is bitumous coal-based. In some embodiments, the activated carbon is coconut-based. Other types and sources of carbon (such as, but not limited to, wood) may also be used and are specifically contemplated. In addition, combinations of two or more types of carbon may be used (e.g., together or sequentially) depending on their respective adsorption efficacies for specific chemical compounds of interest, which compounds may contribute to the color, odor, and/or flavor of the buffered vinegar product.

In some embodiments, the invention provides a method of treating a vinegar product, comprising combining the vinegar product with one or more types of activated carbon, wherein the vinegar product comprises a concentrated buffered vinegar or a simple buffered vinegar, and wherein the activated carbon comprises powdered activated carbon (PAC) or granular activated carbon (GAC); and separating the activated carbon from the vinegar product after a specified time, yielding a treated vinegar product, wherein the treated vinegar product is substantially clear and colorless as measured by absorbance at 260 nm, and wherein the treated vinegar product has a mild vinegar flavor.

In some embodiments, the concentrated buffered vinegar comprises 300 grain vinegar neutralized by a neutralizing agent, concentrated by heat, and adjusted to pH 5.6.

In some embodiments, the simple buffered vinegar comprises 300 grain vinegar neutralized by a neutralizing agent and adjusted to pH 6.0.

In some embodiments, the activated carbon is sourced from at least one of coal, coconut, and wood.

In some embodiments, said combining comprises pumping the vinegar product through one or more columns each comprising a bed of GAC.

In some embodiments, the vinegar product is pumped through the column at a flow rate sufficient to provide an empty bed contact time (EBCT) of at least about 70 minutes.

In some embodiments, said combining comprises pumping the vinegar product through two or more columns plumbed in a series.

In some embodiments, said separating comprises collecting an effluent and filtering the effluent using a filter having a pore size of about 0.45 microns.

In some embodiments, said combining comprises mixing the vinegar product with the activated carbon in a batch process.

In some embodiments, the vinegar product and the activated carbon are mixed with intermittent or constant agitation for about one to ten days.

In some embodiments, said separating comprises passing the mixture through one or more filters.

In some embodiments, the filters each have a pore size of about one micron or less.

In some embodiments, the GAC is pulverized to a powder form.

In some embodiments, the invention provides a treated vinegar product having reduced color, odor, and flavor, produced by a process comprising providing a vinegar product to be treated; combining the vinegar product with one or more types of activated carbon, wherein the vinegar product comprises a concentrated buffered vinegar or a simple buffered vinegar, and wherein the activated carbon comprises powdered activated carbon (PAC) or granular activated carbon (GAC); and separating the activated carbon from the vinegar product after a specified time, yielding the treated vinegar product, wherein the treated vinegar product is substantially clear and colorless as measured by absorbance at 260 nm, and wherein the treated vinegar product has a mild vinegar flavor.

Additional features and advantages of the present invention are described further below. This summary section is meant merely to illustrate certain features of the invention, and is not meant to limit the scope of the invention in any way. The failure to discuss a specific feature or embodiment of the invention, or the inclusion of one or more features in this summary section, should not be construed to limit the invention as claimed.

### BRIEF DESCRIPTION OF THE DRAWINGS

The foregoing summary, as well as the following detailed description of certain embodiments of the application, will be better understood when read in conjunction with the appended drawings. For the purposes of illustrating the systems and methods of the present application, there are shown in the drawings preferred embodiments. It should be understood, however, that the application is not limited to the precise arrangements and instrumentalities shown. In the drawings:

FIG. 1 shows a schematic of an illustrative system for activated carbon treatment in a continuous process, according to some embodiments of the invention;

FIG. 2 shows a schematic of an illustrative system for activated carbon treatment in a batch process, according to some embodiments of the invention;

FIG. 3 shows a schematic of an illustrative filtration system for carbon removal, according to some embodiments of the invention;

FIG. 4 shows the color difference between untreated and activated carbon-treated samples of concentrated buffered vinegar; and

FIG. 5 shows the color difference between untreated and activated carbon-treated samples of simple buffered vinegar.

### DETAILED DESCRIPTION

In spite of its known effectiveness in various applications in the food industry as described above, vinegar carries a characteristic smell/odor that can detract from consumers' acceptance of food products having vinegar as an ingredient. This objectionable characteristic of vinegar is particularly obvious in packaged ready-to-cook raw meats, where a prominent vinegar smell may be detected when the package is opened.

Industrial vinegar is produced in a two-stage fermentation. In the first stage, carbohydrates found in the raw material are converted by yeast to ethanol. Then, acetic acid bacteria (e.g., Acetobacter and Gluconobacter) convert the ethanol into vinegar. The flavor of the vinegar depends on the distillation process for ethanol separation from the fermentation broth and the presence of microbial metabolite by-products of the two-step fermentation.

Vinegar may be used in the meat industry, for example, after neutralizing the acetic acid using a neutralizing agent such as sodium carbonate, sodium bicarbonate, potassium carbonate, potassium bicarbonate, or a combination thereof and adjusting the pH by addition of un-neutralized vinegar, yielding a buffered vinegar. In order to facilitate production of the buffered vinegar at locations far from the point of use, a concentrated form of the buffered vinegar may be used to minimize volume on storage and transportation. Processes for preparing buffered vinegar are described, for example, in U.S. Pat. Nos. 8,877,280 and 8,182,858, both of which are incorporated by reference herein in their entirety

The process for concentrating neutralized vinegar typically involves a heating step to remove water. This heating step can result in color darkening because of heat-induced chemical reactions, and the product may acquire a smell that is characteristic of a “cooked” product and is a departure from the characteristic vinegar smell. Depending upon the food product in which the concentrated buffered vinegar is used, the color and/or smell may result in a deviation from acceptable norms of food product quality.

The present invention addresses such problems and provides a decolorized buffered vinegar product with a mild characteristic vinegar flavor. The removal of color from the buffered vinegar (concentrated or simple) according to embodiments of the present invention may be performed using an adsorption process, such as an activated carbon adsorption process. Preferably, the color removal process can also remove secondary microbial metabolites present in the unprocessed vinegar that is used to make the buffered vinegar.

Activated carbon may be used in the present invention in granular or powder form. Both have advantages and disadvantages. Powdered activated carbon (PAC) has a higher surface area, which can result in faster processing times. However, PAC is mainly used in batch processes and can require meticulous filtration to remove very fine particles from the treated liquid before it can be used in food products. In general, membrane filtration technology with very fine pores is required. On the other hand, granular activated carbon (GAC) may be used in a batch or continuous process with less rigorous filtration requirements because of the larger particle size. In a continuous process, a food product that needs to be treated is pumped through a carbon bed. The used GAC may be regenerated for reuse. In some embodiments, in order to avoid handling of activated carbon and/or to facilitate disposal of spent carbon, fixed carbon beds may be used, where the liquid to be decolorized is passed through the bed until the bed is saturated with the colored constituents.

Activated carbon useful in the present invention can be manufactured from different sources, such as, but not limited to, coal, coconut, and wood. These different types of activated carbon may show different affinities for the chemical compounds to be removed from the buffered vinegar (odor-active components, color bodies, etc.), thus resulting in different adsorption capabilities for individual chemical compounds. Removal of color and flavor from buffered vinegar (concentrated or simple) may be achieved using one carbon type, or a combination of two or more different carbon types, which may be selected, for example, after screening the adsorption efficacy of the carbon types on the compounds of interest.

The compounds responsible for the harsh flavor of raw vinegar produced by aerobic bacterial fermentation of ethanol were determined as follows. The type of vinegar formed from ethanol ferment is classified as “distilled vinegar”. Typically, the ethanol ferment contains a maximum of 12% w/w acetic acid. To produce a 300 grain (300 g acetic acid/L) industrial strength vinegar, the ethanol ferment is concentrated by freeze concentration, whereby water in the form of ice crystals is removed. A 300 grain freeze-concentrated vinegar was obtained from an industrial vinegar supplier. Table 1 shows amounts of chemical compounds present in three vinegar product samples produced therefrom. ND=not found; HNV=heat-concentrated neutralized vinegar (neutralized using a neutralizing agent comprising primarily a bicarbonate or carbonate of potassium); and HNV pH 5.6=HNV with pH adjusted to 5.6 by addition of 300 grain vinegar after concentration.

TABLE 1

| | 300 Grain | | HNV |
|---|---|---|---|
| Compound, ng/mL | Vinegar | HNV | pH 5.6 |
| Acetaldehyde | 9.65 | 0.29 | 120 |
| Methyl acetate | 5686 | 268 | 8226 |
| Ethyl acetate | 145974 | 59 | 52052 |
| Ethyl propionate | 5.2 | ND | Not reported |
| 2,3-Butanedione (diacetyl) | 4909 | 490 | 7583 |
| 3-Hydroxy-2-butanone (acetoin) | 45736 | 6797.7 | 2126 |
| 2-Ethyl-3,5-dimethylpyrazine | 3.8 | 0.78 | 79.2 |
| Furfural | 117 | 1.6 | Not reported |
| Tetramethylpyrazine | 3.2 | 1.52 | 61.3 |
| 2,3-Butanediol diacetate | 51 | ND | Not reported |
| Benzaldehyde | 226 | 4.72 | 212 |
| Alpha terpinol | 24.4 | ND | Not reported |
| Ethyl phenylethyl acetate | 20 | ND | Not reported |
| 3,5-Dimethylbenzaldehyde | 20.6 | ND | Not reported |

Flavor characteristics of the 300 grain vinegar and the heat-concentrated neutralized vinegar with pH adjusted to 5.6 are shown in Table 2. Appearance and odor characteristics of the vinegar samples were analyzed by an experienced 10-member sensory panel.

TABLE 2

| Sample | Color | Odor |
|---|---|---|
| 300 Grain Vinegar | light yellow/gold | vinegar > fruity nail polish |
| | | remover > buttery/dairy |
| HNV pH 5.6 | dark gold/brown | brothy/malty > stinky |
| | | socks/shoes > vinegar > |
| | | buttery/dairy |

Gas Chromatography Olfactometry (GC-O) of the samples in Table 2 compared with constituent compounds listed in Table 1 shows the compounds that contributed to the odors of the three sample vinegars. The brothy flavor note in the HNV pH 5.6 may be caused by the presence of pyrazines such as 2-ethyl-3,5-dimethyl pyrazine. The 300 grain vinegar contained high levels of methyl acetate, ethyl acetate, 2,3-butanedione, and 3-hydroxy-2-butanone, consistent with the strong “fingernail polish remover” and “buttery/dairy” flavor notes. The HNV pH 5.6 sample contained pyrazines and short chain fatty acids such as 3-methyl butanoic acid (not listed in Table 1) causing rancid/fecal flavor notes.

Treatments using activated carbon adsorption processes according to embodiments of the present invention can be used to modulate the undesirable color and flavor notes not only of 300 grain vinegar, but also of vinegar products derived from 300 grain vinegar. Various illustrative treatments according to certain embodiments of the present invention are described in the Examples below. In the Examples, “concentrated buffered vinegar” refers to HNV pH 5.6, and “simple buffered vinegar” refers to simple buffered vinegar pH 6.0. The carbon dosage is specified as a percent (w/w) of concentrated or simple buffered vinegar product treated.

### EXAMPLES

### Example 1

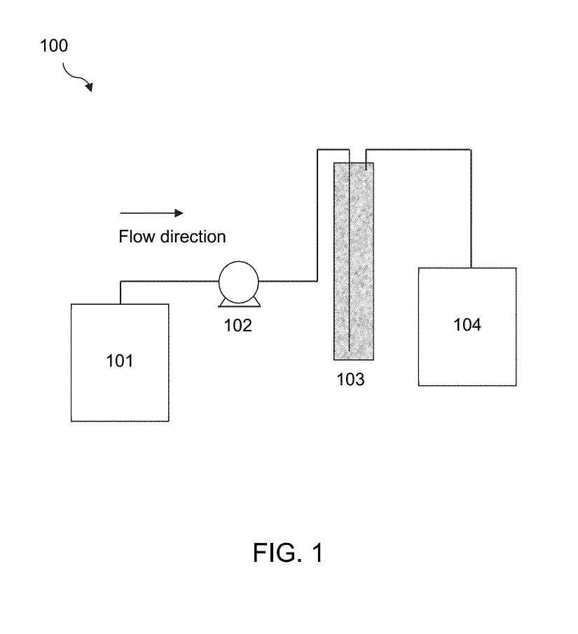

Granular activated carbon (GAC) was used to remove odor and color of concentrated buffered vinegar in a two-stage process. For this treatment, acid-washed GAC, HPC Maxx AW830 (Calgon Carbon, Moon Township, Pa.), was used in a 2-inch diameter 35-inch long stainless steel column. FIG. 1 shows a schematic of an illustrative column-based carbon treatment system 100 for a continuous process according to some embodiments of the invention, comprising a reservoir 101, a pump 102, a column 103, and a collection tank 104. The GAC can be wetted (e.g., with water and/or diluted 300 grain white distilled vinegar) for at least 24 hours. In some embodiments, vinegar may be preferred for the wetting to prevent decline in titratable acidity of concentrated buffered vinegar. Industrial strength vinegar, here 300 grain vinegar, was diluted with purified water to have 5-10% acidity and used to wet the GAC. In other embodiments another high grain vinegar, such as 200 grain vinegar, may be similarly diluted, or a standard strength vinegar may be used for wetting. The column was filled with dry carbon first, then wetting solution was pumped. After 24 hours, the column was drained. (Alternatively, carbon can be wetted in a container, drained, and then placed into the column.) After draining the wetting solution, concentrated buffered vinegar was pumped into the column and the effluent was collected until desired reduction in absorbance was reached, indicating saturation of the GAC. The column was fed from the bottom and the product was overflowed from a short pipe (outlet) at the top. However, in other embodiments, the direction of flow inside the column may be reversed (e.g., the column may be fed from the top and the product can be drawn from the bottom using a longer pipe inside the column). The flow rate of the feed was calculated based on 70 minutes empty bed contact time (EBCT). The formula for the flow rate of concentrated buffered vinegar is given below.

$$Flow rate = \frac{Empty Bed Volume of Column , {m}^{3}}{EBCT , min}$$

At the end of the first stage process, spent carbon in the column was removed and discarded. Then, the column was filled with fresh pre-wetted GAC. (Alternatively, the column may be filled with unused GAC and the same wetting procedures may be followed as in the first stage). The effluent from the first stage treatment was pumped into the column at a flow rate 50% higher in EBCT than that used in the first stage process. When all the first stage effluent was passed through the second stage column, the resulting second stage effluent was then filtered through a 0.45 micron filter (EMD Millipore HVLP09050) on a Buchner funnel under vacuum, or a 1 micron polypropylene filter cartridge (Pentek DGD-2501) in a Pentek Big Blue Housing. For Test #1, the carbon dosages were 2% and 2.85% for the first and second stages, respectively. For Test #2, the carbon dosages were 2% and 4% for the first and second stages, respectively.

### Example 2

Powdered activated carbon (PAC) was used to remove odor and color of concentrated buffered vinegar. For this test, Pulsorb WP640 (Calgon Carbon, Moon Township, Pa.) was used. Concentrated buffered vinegar was mixed with PAC at 5% (Test #3) and at 9% (Test #4) concentration. To prevent change in the titratable acidity, industrial strength, 300 grain vinegar, was added to the concentrated buffered vinegar prior to introduction of PAC. Carbon cake was formed over time, and the vinegar-PAC mix was agitated intermittently to prevent powder settlement. The PAC was in contact with the concentrated buffered vinegar for 1 day with constant agitation (Test #4) or 8 days with few agitations (e.g., agitation twice a day; Test #3). At the end of the process, the PAC was removed using a 0.45 micron filter (EMD Millipore HVLP09050) on a Buchner funnel under vacuum.

### Example 3

Granular activated carbon (GAC) was used to remove odor and color of concentrated buffered vinegar in a batch process. For this test, acid-washed GAC, HPC Maxx AW830 (Calgon Carbon, Moon Township, Pa.) was used. Concentrated buffered vinegar was mixed with GAC at 9% concentration (Test #5). To prevent change in the titratable acidity, industrial strength, 300 grain vinegar, was added to the concentrated buffered vinegar prior to introduction of GAC. The vinegar-GAC mix was recirculated for 1 to 3 days using a diaphragm pump to prevent carbon granules from settling. At the end of the process, the GAC was removed using a series of filters having different pore sizes, including a 5 micron polypropylene filter cartridge (H2O Distributors LF-PP-005-508-B), a 1 micron polypropylene filter cartridge (Pentek DGD-2501), and a 0.35 micron pleated filter cartridge (Flow-Max FM-BB-20-035), each in a Pentek Big Blue Housing.

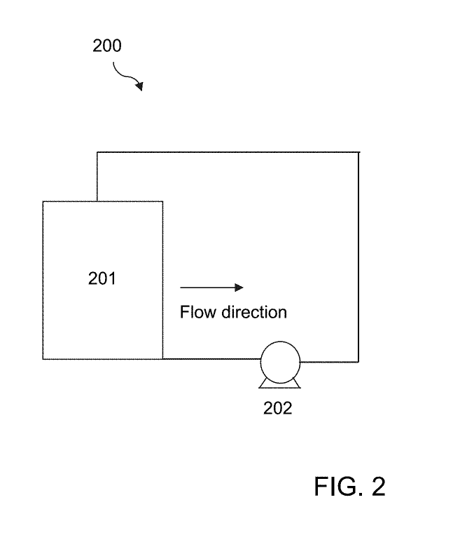

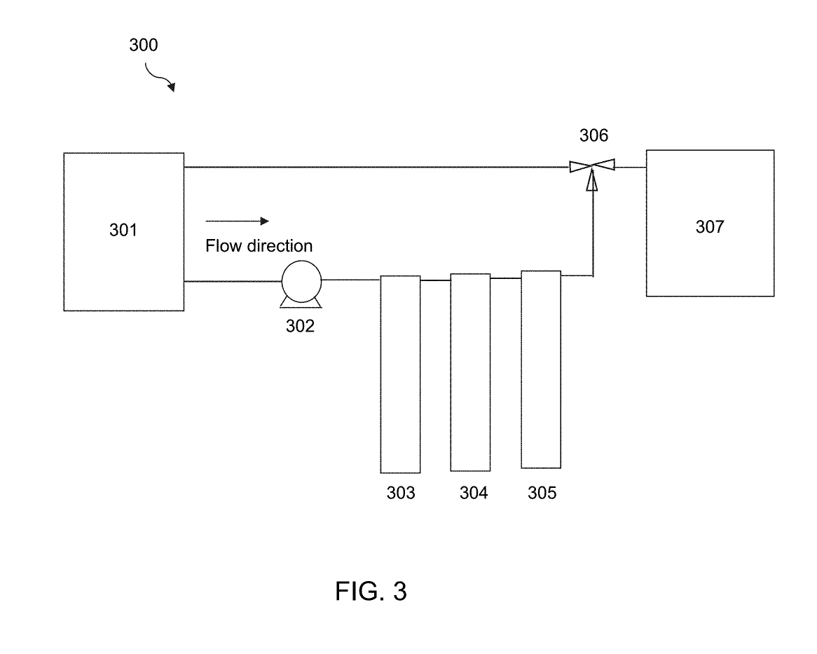

FIG. 2 shows a schematic of an illustrative carbon treatment system 200 for a batch process according to some embodiments of the invention, comprising a reservoir 201 and a pump 202. In other embodiments, the flow direction may be reversed. FIG. 3 shows a schematic of an illustrative filtration system 300 for removal of carbon from treated product, comprising a reservoir 301, a pump 302, three cartridge filters 303, 304, 305 each in a housing, a valve 306, and a collection tank 307 for effluent. Filtration system 300 may be used to remove carbon from product produced in either a batch process or a continuous process. The number of the filters in this system can be increased or decreased, for example, depending on the concentration of carbon particles floating in the effluent from the final filter. In some embodiments, a portion of the filter effluent may be circulated back to the reservoir for a period of time to allow carbon cake to build up on the filters to aid in carbon particle retention. Once carbon cake layer is built up on the filters, and filtrate is free of carbon particles, the rest of the effluent can then be passed through the filtration system to obtain the final desired product.

### Example 4

Concentrated buffered vinegar was treated with different types of activated carbon in powder form at 5% concentration. Pulsorb WP640 and PWA (Calgon Carbon, Moon Township, PA), two different types of coal-based powdered activated carbon (PAC), were used as-is (Test #6 and Test #7, respectively). OLC AW 12x40 (Calgon Carbon, Moon Township, Pa.), a type of coconut-based granular activated carbon (GAC), was pulverized and used in a powder form (Test #8). Activated carbon was in contact with concentrated buffered vinegar for 8 days with intermittent agitation. Samples were transported to an outside laboratory during that period. At the end of the process, the PAC was removed using a 0.45 micron filter (EMD Millipore HVLP09050) on a Buchner funnel under vacuum.

### Example 5

Simple buffered vinegar was treated with HPC Maxx AW830 (Calgon Carbon, Moon Township, Pa.) in a column as described in Example 1 at a carbon dosage of 1.5% (Test #9). GAC was wetted at least 24 hours with diluted 300 grain vinegar containing 5-10% titratable acidity, drained, and placed into the column. Then, simple buffered vinegar was passed through the column (carbon bed) at a flow rate to have 70 minutes of EBCT. Simple buffered vinegar was treated through the column for only a single pass. At the end of the process, the collected product was filtered through a 0.45 micron filter (EMD Millipore HVLP09050) on a Buchner funnel under vacuum. The collected product and its control were analyzed for volatile compounds using headspace analysis and for absorbance at 260 nm.

### Example 6

Concentrated buffered vinegar was treated with HPC Maxx AW830 (Calgon Carbon, Moon Township, Pa.) in a column that was scaled up based on the column described in Example 1. The height of the column was increased, while the height to diameter ratio of the carbon bed was kept the same. In some embodiments, a column that has been scaled up as described above may be divided into two or more sections (e.g., plumbed in a series) if needed (e.g., to account for limited ceiling height). GAC was wetted with diluted 300 grain white distilled vinegar having 5-10% titratable acidity for at least 24 hours. After 24 hours, the GAC was drained and then placed into the column. After filling the column, concentrated buffered vinegar was pumped into the column, and its flow rate was calculated based on the same velocity of the vinegar passing through the column as in the first stage of Example 1. Velocity was calculated by dividing the surface area of the column by flow rate of the vinegar. For this experiment, concentrated buffered vinegar was treated through the column for only a single pass. Total experiment time was about 72-80 hours. Samples of treated product were taken during the experiment at the end of Day 1, Day 2, and Day 3 (at the end of the experiment).

The treated vinegar was filtered through a system such as that shown in FIG. 3, which may comprise, for example, a series of filters having different pore sizes, including a 5 micron polypropylene filter cartridge (H2O Distributors LF-PP-005-508-B), a 1 micron polypropylene filter cartridge (Pentek DGD-2501), and a 0.35 micron pleated filter cartridge (Flow-Max FM-BB-20-035), each in a Pentek Big Blue Housing. The treated vinegar was sampled at various stages to have approximate carbon dosages of 5.5%, 4.0%, and 2.8% for Test #10 (Day 1), Test #11 (Day 2), and Test #12 (Day 3), respectively. The collected samples and their control (Control 3) were analyzed for volatile compounds using headspace analysis and for absorbance at 260 nm.

### Example 7

Concentrated buffered vinegar was treated in a column as described in Example 1 in a two-stage process. In the first stage, HPC Maxx AW830 (Calgon Carbon, Moon Township, Pa.) was wetted at least 24 hours with diluted 300 grain vinegar containing 5-10% titratable acidity, drained, and placed into the column. After filling the column with the wetted GAC, concentrated buffered vinegar was pumped into the column at a flow rate equivalent to 70 minutes of EBCT. The carbon dosage for the first stage was 2.3% (Test #13). At the end of the first stage, the spent carbon in the column was discarded. OLC AW 12x40 (Calgon Carbon, Moon Township, Pa.) was wetted with diluted 300 grain vinegar containing 5-10% titratable acidity for at least 24 hours and placed into the column. The effluent from the first treatment stage was introduced into the second stage column at a flow rate to have 50% more EBCT than in the first stage. The carbon dosage for the second stage was 2.5% (Test #14). The collected product was filtered with a 1 micron polypropylene filter cartridge (Pentek DGD-2501) in a Pentek Big Blue Housing. The collected samples were analyzed for volatile compounds using headspace analysis and for absorbance at 260 nm. In alternative embodiments of the present invention using sequential carbon treatments, the concentrated buffered vinegar may be passed sequentially through two or more columns that are plumbed in a series and filled with the same or different types of carbon (sourced from coal, coconut, wood, etc.).

### Example 8

Concentrated buffered vinegar was treated with a wood-based granular activated carbon (GAC), Nuchar WV-B-30 (Ingevity, North Charleston, S.C.), at 2.5% concentration (Test #15) and 5.0% concentration (Test #16). The wood-based GAC was soaked in the concentrated buffered vinegar for 14 days with intermittent agitation (e.g., twice a day). At the end of the process, the GAC was separated from the concentrated buffered vinegar using a 0.45 micron filter (EMD Millipore HVLP09050) on a Buchner funnel under vacuum. All final filtrates were analyzed for absorbance at 260 nm. Filtrate from Test #15 was also analyzed for volatile compounds.

### Results for Examples 1-8

Secondary microbial metabolites formed during fermentation of ethanol to vinegar were removed by adsorption on activated carbon. Heating also darkens the color of vinegar products and imparts a smell un-characteristic of vinegar smell. Adequacy of removal of unwanted microbial metabolites and heat-induced reaction products was found to correlate with color removal and was determined by absorbance of the treated liquid as measured using a spectrophotometer. A clear water-like liquid with a faint vinegar smell was produced when the buffered vinegar products were treated by the activated carbon adsorption processes.

Table 3 shows a comparison of the PAC and GAC treatments of simple and concentrated buffered vinegars from Examples 1-8. The results in Table 3 show that activated carbon treatments using either powdered or granular forms were effective in removing the color of the HNV pH 5.6 product and removal of the colored constituents. The treatments may have also removed the compounds responsible for the “stinky socks/shoes” odor note. Thus, a clear product with just a slight vinegar note (and, in some examples, a slight buttery flavor note) was produced. TA=titratable acidity; Control 1 and Control 3=HNV pH 5.6 (different lots); Control 2=simple buffered vinegar pH 6.0.

TABLE 3

| | pH | TA, % | Color | Odor |
|---|---|---|---|---|
| Test #1 | 5.40-5.80 | 3.50-4.00 | Clear | Slight vinegar, |
| | | | | slight buttery/dairy |
| Test #2 | 5.40-5.80 | 3.50-4.00 | Clear | Slight vinegar |
| Test #3 | 5.40-5.80 | 3.50-4.00 | Clear | Slight vinegar |
| Test #4 | 5.40-5.80 | 3.50-4.00 | Clear | Slight vinegar |
| Test #5 | 5.40-5.80 | 3.50-4.00 | Clear | Slight vinegar |
| Test #6 | 5.40-5.80 | 3.50-4.00 | Clear | Slight vinegar |
| Test #7 | 5.40-5.80 | 3.50-4.00 | Clear | Slight vinegar |
| Test #8 | 5.40-5.80 | 3.50-4.00 | Clear | Slight vinegar |
| Test #9 | 5.85-6.15 | 1.00-1.30 | Clear | Slight vinegar |
| Test #10 | 5.40-5.80 | 3.50-4.00 | Clear | Slight vinegar |
| Test #11 | 5.40-5.80 | 3.50-4.00 | Clear | Slight vinegar |
| Test #12 | 5.40-5.80 | 3.50-4.00 | Clear | Slight vinegar |
| Test #13 | 5.40-5.80 | 3.50-4.00 | Clear | Vinegar |
| Test #14 | 5.40-5.80 | 3.50-4.00 | Clear | Slight vinegar |
| Test #15 | 5.40-5.80 | 3.50-4.00 | Clear | Slight vinegar, |
| | | | | slight buttery/dairy |
| Test #16 | 5.40-5.80 | 3.50-4.00 | Clear | Slight vinegar |
| Control 1 | 5.40-5.80 | 3.50-4.00 | Light brown | Vinegar, malty, |
| | | | | buttery/dairy |
| Control 2 | 5.85-6.15 | 1.00-1.30 | Light amber | Vinegar, buttery/dairy |
| Control 3 | 5.40-5.80 | 3.50-4.00 | Light brown | Vinegar/pungent, |
| | | | | malty, buttery/dairy |

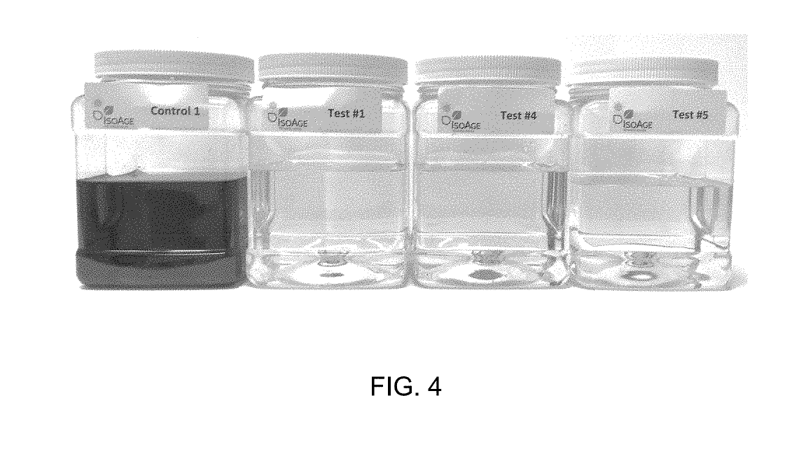

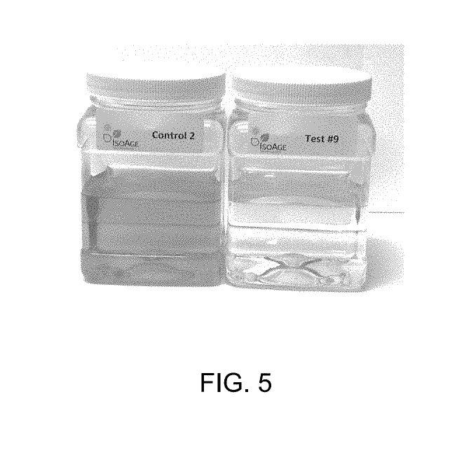

FIGS. 4 and 5 show the color differences between untreated and carbon-treated concentrated buffered vinegar samples (FIG. 4), and untreated and carbon-treated simple buffered vinegar samples (FIG. 5). FIG. 4 shows, from left to right: Control 1: HNV pH 5.6; Test #1: HPC Maxx AW830 in a continuous system at 2% and 2.85%; Test #4: Pulsorb WP640 in a batch system at 9%; and Test #5: HPC Maxx AW830 in a batch system at 9%. FIG. 5 shows, from left to right: Control 2: simple buffered vinegar pH 6.0; and Test #9: HPC Maxx AW830 in a continuous system at 1.5%.

Spectral scanning was used for evaluation of treated product color. A UV-Vis spectrophotometer (UV-2450, Shimadzu) was used to measure absorbance of concentrated buffered vinegar and decolorized concentrated buffered vinegar at wavelengths from 210 nm to 500 nm. Lower absorbance values at a given wavelength indicate that the material contains fewer color bodies. For instance, deionized water, which is transparent and clear, had 0-0.001 absorbance at wavelengths from 210 nm to 500 nm. Table 4 shows the absorbances measured for GAC- and PAC-treated concentrated buffered vinegars. Percentages indicate the actual carbon dosages for the tests.

TABLE 4

| | | GAC | | | PAC | |
|---|---|---|---|---|---|---|
| Wave- | | Test #1 | Test #2 | Test #5 | Test #3 | Test #4 |
| length, | Control | Two stage | Two stage | HPC | Pulsorb | Pulsorb |
| nm | 1 | 2%-2.85% | 2%-4% | 9% | 5% | 9% |
| 210 | 4.318 | 3.569 | 3.478 | — | 3.569 | 3.438 |
| 250 | 4.318 | 0.605 | 0.564 | 0.717 | 0.728 | 0.588 |
| 300 | 3.158 | 0.157 | 0.147 | — | 0.191 | 0.144 |
| 350 | 1.844 | 0.04 | 0.038 | — | 0.058 | 0.064 |
| 400 | 1.042 | 0.008 | 0.007 | — | 0.009 | 0.012 |
| 450 | 0.663 | 0.003 | 0.002 | — | 0.001 | 0.005 |
| 500 | 0.436 | 0 | 0 | — | 0 | 0.003 |

Table 5 shows results from headspace analysis of decolorized and deodorized concentrated buffered vinegars. Pyrazines formed during heat evaporation of neutralized vinegar were removed by the PAC and GAC powder adsorption treatments. Two-stage treatment of the HNV pH 5.6 with GAC reduced the level of diacetyl in the product to 1190 ng/mL and acetoin to 1968 ng/mL. Treatment with Pulsorb PAC reduced diacetyl and acetoin to 389 ng/mL and 807 ng/mL, respectively.

TABLE 5

| | | GAC | | | GAC |
|---|---|---|---|---|---|
| | | Test #1 | PAC | PAC | powder |
| | | Two stage | Test #6 | Test #7 | Test #8 |
| Compound, ng/mL | Control 1 | 2%-2.85% | Pulsorb 5% | PWA 5% | OLC 5% |
| Acetaldehyde | 120 | 94 | 27 | 30 | 27.9 |
| Methyl acetate | 8226 | 16150 | 3477 | 3949 | 4715 |
| Ethyl acetate | 52052 | 8648 | 3659 | 4230 | 2226 |
| Ethanol | 10507 | 9287 | 5694 | 4794 | 4770 |
| 2,3-butanedione (diacetyl) | 7583 | 1190 | 389 | 390 | 352 |
| 3-hydroxy-2-butanone (acetoin) | 2126 | 1968 | 807 | 731 | 651 |
| 2-ethyl-5-methylpyrazine | 14.6 | 0.52 | None | None | None |
| 2,3,5-trimethylpyrazine | 142 | 1.39 | None | None | None |
| 2-ethyl-3,6-dimethylpyrazine | 20.2 | None | None | None | None |
| 2-ethyl-3,5-dimethylpyrazine | 79.2 | 0.97 | None | None | None |
| Tetramethylpyrazine | 61.3 | 2.25 | None | None | None |
| Benzaldehyde | 212 | 9.7 | 26 | 31 | 27.3 |

Table 6 shows absorbance and headspace analysis of decolorized and deodorized simple buffered vinegar and its control. GAC treatment of simple buffered vinegar reduced the levels of acetaldehyde, methyl acetate, ethyl acetate, diacetyl, pyrazines, and benzaldehyde. However, GAC treatment increased the acetoin concentration.

TABLE 6

| | | GAC |
|---|---|---|
| | | Test #9 |
| Compound, ng/mL | Control 2 | HPC 1.5% |
| Absorbance at 260 nm | 2.319 | 0.323 |
| Acetaldehyde | 37.2 | 14.5 |
| 2-methylpropanal | 15.8 | 5.5 |
| Methyl acetate | 135 | 63 |
| Ethyl acetate | 11321 | 2091 |
| Ethanol | 5371 | 3062 |
| 2,3-butanedione (diacetyl) | 3281 | 2149 |
| 2,3-pentanedione | 0 | 0 |
| Methyl pyrazine | 34.9 | 24.8 |
| 3-hydroxy-2-butanone (acetoin) | 1854 | 2563 |
| 2,5(and 6)-dimethylpyrazine | 37.4 | 17.6 |
| Trimethylpyrazine | 206 | 117 |
| 3-ethyl-2,5-dimethylpyrazine | 0.3 | 0.1 |
| 2-ethyl-3,5-dimethylpyrazine | 75 | 18.3 |
| Benzaldehyde | 32.2 | 3.2 |

Table 7 shows absorbance and headspace analysis of decolorized and deodorized concentrated buffered vinegar samples taken from various stages as described in Example 6, and the associated control. As carbon dosage decreased, absorbance of the treated concentrated buffered vinegar increased. The same trend was also observed for acetaldehyde, methyl acetate, ethyl acetate, ethanol, diacetyl, acetoin, and benzaldehyde concentrations in the GAC-treated concentrated buffered vinegar samples.

TABLE 7

| | | GAC | GAC | GAC |
|---|---|---|---|---|
| | | Test #10 | Test #11 | Test #12 |
| Compound, ng/mL | Control 3 | 5.5% | 4.0% | 2.8% |
| Absorbance at 260 nm | 4.061 | 0.41 | 0.53 | 0.66 |
| Acetaldehyde | 31.1 | 6.3 | 10.1 | 11.4 |
| 2-methylpropanal | 23.2 | 1.1 | 1.6 | 4.8 |
| Methyl acetate | 493 | 153 | 206 | 256 |
| Ethyl acetate | 22721 | 2225 | 3388 | 4028 |
| Ethanol | 5689 | 2845 | 3317 | 3593 |
| 2,3-butanedione (diacetyl) | 5664 | 264 | 686 | 914 |
| 2,3-pentanedione | 16.4 | None | None | None |
| Methyl pyrazine | 123 | None | None | None |
| 3-hydroxy-2-butanone (acetoin) | 6956 | 1016 | 2744 | 3834 |
| 2,5-dimethylpyrazine | 45.8 | None | None | None |
| Trimethylpyrazine | 118 | None | None | None |
| 2,3-dimethy1-5-ethylpyrazine | 9.19 | None | None | None |
| Benzaldehyde | 33.1 | 8.3 | 7.2 | 6.8 |

Table 8 shows absorbance and headspace analysis of decolorized and deodorized concentrated buffered vinegar treated using different types of GAC as described in Example 7. Coconut-based GAC in the second stage removed more acetoin than coal-based GAC in the second stage (see, e.g., Table 5 Test #1). However, Test #14 removed less diacetyl than Test #1. This may be related to coconut-based GAC having less porous structure as compared to coal-based GAC. Diacetyl removal was comparable between the coconut-based and coal-based activated carbon types when they were used in powder form (see, e.g., Table 5 Tests #6-8).

TABLE 8

| | GAC | GAC |
|---|---|---|
| | Test #13 | Test #14 |
| | One stage | Two stage |
| Compound, ng/mL | 2.3% | 2.3%-2.5% |
| Absorbance at 260 nm | 0.792 | 0.627 |
| Acetaldehyde | 31.0 | 18.9 |
| 2-methylpropanal | 4.8 | 2.3 |
| Methyl acetate | 184 | 188 |
| Ethyl acetate | 13862 | 12659 |
| Ethanol | 6616 | 6044 |
| 2,3-butanedione (diacetyl) | 2699 | 1681 |
| 2,3-pentanedione | 0 | 0 |
| Methyl pyrazine | 50.9 | 37.5 |
| 3-hydroxy-2-butanone (acetoin) | 3045 | 1498 |
| 2,5(and 6)-dimethylpyrazine | 41.3 | 21.9 |
| Trimethylpyrazine | 151 | 56 |
| 3-ethyl-2,5-dimethylpyrazine | 1.0 | 0.3 |
| 2-ethyl-3,5-dimethylpyrazine | 3.3 | 0.8 |
| Benzaldehyde | 4.6 | 2.8 |

In an additional experiment, concentrated buffered vinegar was treated with OLC AW 12x40 (Calgon Carbon, Moon Township, Pa.) in the first stage and HPC Maxx AW830 (Calgon Carbon, Moon Township, Pa.) treatment in the second stage. To achieve absorbance similar to all-coal GAC-treated concentrated buffered vinegar at 260 nm, higher second stage carbon dosages were needed (2% and 4.15%, at the first and second stages, respectively), due to the less porous structure of coconut-based GAC as compared to coal-based GAC. Porous structure of the two different types of GAC may affect particle dimensions. Coconut-based GAC may be more compacted than coal-based GAC.

Table 9 shows a headspace analysis of concentrated buffered vinegars treated using a wood-based GAC. Pyrazines formed during concentration of neutralized vinegar by thermal evaporation were completely removed by the wood-based GAC (data not shown in Table 9). When the wood-based GAC was used to treat the concentrated buffered vinegar in a column at an approximate carbon dosage of 2.8%, the effluent was more brown in color as compared to the same feed-stock treated with coal-based GAC. However, wood-based GAC may also be used in a sequential multi-stage process along with coal-based and/or coconut-based GAC.

TABLE 9

| | GAC | GAC |
|---|---|---|
| | Test #15 | Test #16 |
| Compound, ng/mL | 2.5% | 5.0% |
| Absorbance at 260 nm | 0.753 | 0.700 |
| Acetaldehyde | 72 | — |
| Methyl acetate | 14715 | — |
| Ethyl acetate | 6055 | — |
| Ethanol | 8698 | — |
| 2,3-butanedione (diacetyl) | 2576 | — |
| 3-hydroxy-2-butanone (acetoin) | 1911 | — |
| Benzaldehyde | 7 | — |

### Example 9

Tables 10 and 11 show compound reduction rankings for four different carbon types used in the treatment of two different vinegar products. Product #1=concentrated buffered vinegar neutralized with a neutralizing agent comprising primarily bicarbonate or carbonate of sodium; Product #2=concentrated buffered vinegar neutralized with a neutralizing agent comprising primarily bicarbonate or carbonate of potassium. OLC is a coconut-based activated carbon; CPG, PS, and PWA are coal-based activated carbons. For each treatment, the carbon concentration used was 5%, and the contact time was 8-9 days. For each compound, the different carbon types were ranked from 1=most removed (M) to 4=least removed (L). Delta (L-M) is the concentration difference of a compound between least (L) and most (M) reduction (ng/mL). Delta (control−M) is the concentration difference of a compound between the control and the treated sample with most (M) reduction (ng/mL). The control was untreated product.

TABLE 10

| | Product #1 | | | | | | |
|---|---|---|---|---|---|---|---|
| | | | | | | | Re- |
| | | | | | Δ | Δ | duction |
| | Carbon Samples | | | | (L-M) | (control - M) | (control- |
| Compound | OLC | CPG | PS | PWA | (ng/mL) | (ng/mL) | M) % |
| acetaldehyde | 1 | 2 | 4 | 3 | 5.9 | 87.9 | 80.6 |
| methyl | 4 | 3 | 1 | 2 | 851 | 4517 | 58.8 |
| acetate | | | | | | | |
| ethyl acetate | 1 | 4 | 2 | 3 | 1928 | 32876 | 96.0 |
| ethanol | 3 | 4 | 1 | 2 | 1631 | 8804 | 80.1 |
| diacetyl | 3 | 4 | 1 | 2 | 66 | 9522 | 98.2 |
| styrene | 1 | 2 | 3 | 4 | 5.3 | 40 | 59.1 |
| acetoin | 2 | 4 | 1 | 3 | 156 | 791 | 77.5 |
| benzaldehyde | 1 | 2 | 3 | 4 | 5.4 | 211.4 | 89.2 |
| SUM | 16 | 25 | 16 | 23 | | | |

TABLE 11

| | Product #2 | | | | | | |
|---|---|---|---|---|---|---|---|
| | | | | | | | Re- |
| | | | | | Δ | Δ | duction |
| | Carbon Samples | | | | (L-M) | (control - M) | (control- |
| Compound | OLC | CPG | PS | PWA | (ng/mL) | (ng/mL) | M) % |
| acetaldehyde | 2 | 4 | 1 | 3 | 10 | 93 | 77.5 |
| methyl | 4 | 3 | 1 | 2 | 1238 | 4749 | 57.7 |
| acetate | | | | | | | |
| ethyl acetate | 1 | 4 | 2 | 3 | 2440 | 49826 | 95.7 |
| ethanol | 1 | 2 | 4 | 3 | 924 | 5737 | 54.6 |
| diacetyl | 1 | 4 | 2 | 3 | 65 | 7231 | 95.4 |
| styrene | 2 | 4 | 1 | 3 | 7 | 43.7 | 60.1 |
| acetoin | 2 | 1 | 4 | 3 | 201 | 1520 | 71.5 |
| benzaldehyde | 2 | 4 | 1 | 3 | 7 | 186 | 87.7 |
| SUM | 15 | 26 | 16 | 23 | | | |

While there have been shown and described fundamental novel features of the invention as applied to the preferred and exemplary embodiments thereof, it will be understood that omissions and substitutions and changes in the form and details of the disclosed invention may be made by those skilled in the art without departing from the spirit of the invention. Moreover, as is readily apparent, numerous modifications and changes may readily occur to those skilled in the art. For example, any feature(s) in one or more embodiments may be applicable and combined with one or more other embodiments. Hence, it is not desired to limit the invention to the exact construction and operation shown and described and, accordingly, all suitable modification equivalents may be resorted to falling within the scope of the invention as claimed. It is the intention, therefore, to be limited only as indicated by the scope of the claims appended hereto.

1. A method of treating a vinegar product, comprising:
combining the vinegar product with one or more types of activated carbon, wherein the vinegar product comprises a concentrated buffered vinegar or a simple buffered vinegar, and wherein the activated carbon comprises powdered activated carbon (PAC) or granular activated carbon (GAC); and
separating the activated carbon from the vinegar product after a specified time, yielding a treated vinegar product,
wherein the treated vinegar product is substantially clear and colorless as measured by absorbance at 260 nm, and
wherein the treated vinegar product has a mild vinegar flavor.

2. The method of claim 1, wherein the concentrated buffered vinegar comprises 300 grain vinegar neutralized by a neutralizing agent, concentrated by heat, and adjusted to pH 5.6.

3. The method of claim 1, wherein the simple buffered vinegar comprises 300 grain vinegar neutralized by a neutralizing agent and adjusted to pH 6.0.

4. The method of claim 1, wherein the activated carbon is sourced from at least one of coal, coconut, and wood.

5. The method of claim 1, wherein said combining comprises pumping the vinegar product through one or more columns each comprising a bed of GAC.

6. The method of claim 5, wherein the vinegar product is pumped through the column at a flow rate sufficient to provide an empty bed contact time (EBCT) of at least about 70 minutes.

7. The method of claim 5, wherein said combining comprises pumping the vinegar product through two or more columns plumbed in a series.

8. The method of claim 5, wherein said separating comprises collecting an effluent and filtering the effluent using a filter having a pore size of about 0.45 microns.

9. The method of claim 1, wherein said combining comprises mixing the vinegar product with the activated carbon in a batch process.

10. The method of claim 9, wherein the vinegar product and the activated carbon are mixed with intermittent or constant agitation for about one to ten days.

11. The method of claim 9, wherein said separating comprises passing the mixture through one or more filters.

12. The method of claim 1, wherein the filters each have a pore size of about one micron or less.

13. The method of claim 1, wherein the GAC is pulverized to a powder form.

14. A treated vinegar product having reduced color, odor, and flavor, produced by a process comprising:
providing a vinegar product to be treated;
combining the vinegar product with one or more types of activated carbon, wherein the vinegar product comprises a concentrated buffered vinegar or a simple buffered vinegar, and wherein the activated carbon comprises powdered activated carbon (PAC) or granular activated carbon (GAC); and
separating the activated carbon from the vinegar product after a specified time, yielding the treated vinegar product,
wherein the treated vinegar product is substantially clear and colorless as measured by absorbance at 260 nm, and
wherein the treated vinegar product has a mild vinegar flavor.
